(19) United States
(12) Patent Application Publication
(10) Pub. No.: US 2024/0256253 A1
(43) Pub. Date: Aug. 1, 2024

(54) METHOD FOR PERFORMING FIRMWARE UPDATE IN ELECTRONIC DEVICE AND MICRO CONTROL UNIT EQUIPPED WITH FIRMWARE UPDATE FUNCTION

(71) Applicant: Artery Technology Co., Ltd., Chongqing (CN)

(72) Inventors: Jie Li, Chongqing (CN); Yiheng Tao, Chongqing (CN)

(73) Assignee: Artery Technology Co., Ltd., Chongqing (CN)

(21) Appl. No.: 18/233,338

(22) Filed: Aug. 14, 2023

(30) Foreign Application Priority Data
Feb. 1, 2023 (CN) 202310084419.9

(51) Int. Cl. G06F 8/65

(52) U.S. Cl. CPC G06F 8/65

(57) ABSTRACT

A method for performing firmware update in an electronic device and a micro control unit equipped with a firmware update function are provided. The method includes: after system reset of the micro control unit, executing an upgrade guiding procedure in an upgrade guiding procedure region by default to start controlling upgrade of a main function procedure in a main function procedure region; checking whether upgrade request information exists, in order to generate a first checking result; in response to the upgrade request information, performing firmware update on multiple sub-regions of the main function procedure region, respectively, to generate an updated main function procedure; performing at least one checking operation to generate at least one checking result; and in response to the at least one checking result, starting executing the updated main function procedure in the main function procedure region.

### BACKGROUND OF THE INVENTION

### 1. Field of the Invention

The present invention is related to electronic device control, and more particularly, to a method performing firmware update in an electronic device and a micro control unit equipped with a firmware updating function.

### 2. Description of the Prior Art

According to the related art, operations of upgrading a micro control unit may comprise first storing a downloaded new firmware code in a fixed non-volatile storage region, and then copying the new firmware code in this fixed non-volatile storage region into another non-volatile storage region at an address for running the firmware, for subsequent execution. As additional memory space is needed to be used as the above-mentioned fixed non-volatile storage region, this is not friendly to micro control units merely having small memory space. Some conventional methods have been proposed to try solving the above-mentioned problem, but may cause some other problems, such as the occurrence of abnormal upgrade. For example, the firmware update process may be interrupted or interfered to lead to errors, which may cause the micro control unit being upgraded to malfunction and become incapable of being upgraded again. Therefore, a novel architecture is needed for realizing a low-cost and robust electronic device control architecture without introducing any side effect or in a way that is less likely to introduce a side effect.

### SUMMARY OF THE INVENTION

It is an objective of the present invention to provide a method performing firmware update in an electronic device and a micro control unit equipped with a firmware updating function, in order to solve the above-mentioned problems and realize a low-cost and robust electronic device control architecture in a way that is less likely to introduce a side effect.

At least one embodiment of the present invention provides a method performing firmware update in an electronic device, where the method may be applied to a micro control unit in the electronic device. The micro control unit may be equipped with a non-volatile memory (NVM), and memory space of the non-volatile memory may comprise a main function procedure region and an upgrade guiding procedure region. The method may comprise: after system reset of the micro control unit, executing an upgrade guiding procedure in the upgrade guiding procedure region by default to start controlling upgrade of a main function procedure in the main function procedure region, wherein the main function procedure region and the upgrade guiding procedure region are arranged to store the main function procedure and the upgrade guiding procedure, respectively; checking whether upgrade request information exists, in order to generate a first checking result, wherein the first checking result indicates that the upgrade request information exists; in response to the upgrade request information, performing firmware update on multiple sub-regions of the main function procedure region, respectively, to generate an updated main function procedure; performing at least one checking operation to generate at least one checking result; and in response to the at least one checking result, starting executing the updated main function procedure in the main function procedure region.

At least one embodiment of the present invention provides a micro control unit equipped with a firmware update function. The micro control unit may comprise a core circuit, and the core circuit may be arranged to control operations of the micro control unit. The micro control unit may further comprise a non-volatile memory coupled to the core circuit, and the non-volatile memory may be arranged to store information, wherein memory space of the non-volatile memory may comprise a main function procedure region and an upgrade guiding procedure region, for storing a main function procedure and an upgrade guiding procedure, respectively. For example, after system reset of the micro control unit, the core circuit executes the upgrade guiding procedure in the upgrade guiding procedure region by default to start controlling upgrade of the main function procedure in the main function procedure region; the core circuit checks whether upgrade request information exists, in order to generate a first checking result, wherein the first checking result indicates that the upgrade request information exists; in response to the upgrade request information, the core circuit performs firmware update on multiple sub-regions of the main function procedure region, respectively, to generate an updated main function procedure; the core circuit performs at least one checking operation to generate at least one checking result; and in response to the at least one checking result, the core circuit starts executing the updated main function procedure in the main function procedure region.

One of multiple advantages of the present invention is that the method and the micro control unit of the present invention can save memory space, having no need to use additional memory space to download the updated main function procedure and then copy the updated main function procedure to the main function procedure region during the firmware update process. In addition, the method and the micro control unit of the present invention can re-update the firmware to recover the system after abnormal firmware update occurs, and more particularly, improve the stability of the system. In comparison with the related art, the method and the micro control unit of the present invention can realize a low-cost and robust electronic device control architecture without introducing any side effect or in a way that is less likely to introduce a side effect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a micro control unit equipped with a firmware update function, an electronic device with the micro control unit installed therein, and a host for providing a new firmware code according to an embodiment of the present invention.

FIG. 2A illustrates a first partial working flow of a main working flow of a method for performing firmware update in an electronic device according to an embodiment of the present invention.

FIG. 2B illustrates a second partial working flow of the main working flow.

FIG. 3 illustrates timer interrupt service function operations involved with the main working flow according to an embodiment of the present invention.

FIG. 4 illustrates some implementation details of the main working flow according to an embodiment of the present invention.

### DETAILED DESCRIPTION

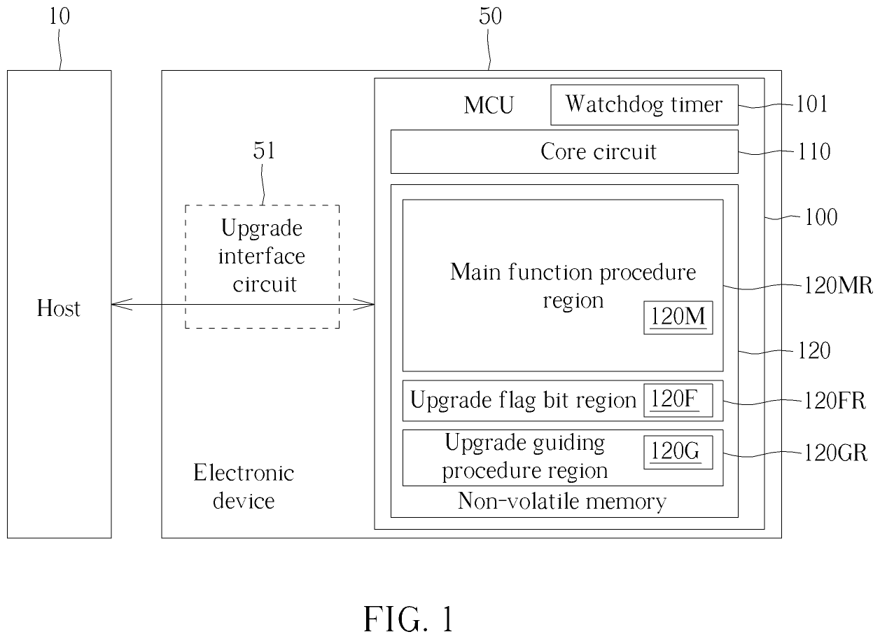

FIG. 1 is a diagram of a micro control unit 100 (labeled “MCU” for brevity) equipped with a firmware update function, an electronic device 50 with an upgrade interface circuit 51 and the micro control unit 100 installed therein, and a host 10 for providing a new firmware code according to an embodiment of the present invention, where the micro control unit 100 may also be referred to as the microcontroller 100, but the present invention is not limited thereto. The micro control unit 100 may comprise a core circuit 110 and a non-volatile memory 120 coupled to the core circuit 110, where the memory space of the non-volatile memory 120 may comprise a main function procedure region 120MR, an upgrade flag bit region 120FR and an upgrade guiding procedure region 120GR, but the present invention is not limited thereto. According to some embodiments, the architecture of the electronic device 50 and/or the micro control unit 100 may vary.

The core circuit 110 may be arranged to control the operations of the micro control unit 100, and the non-volatile memory 120 may be arranged to store information. For example, the core circuit 110 may run the firmware code in the main function procedure region 120MR to control the normal operations of the micro control unit 100 within the electronic device 50. In addition, when there is a need, the core circuit 110 may selectively change an upgrade flag in the upgrade flag bit region 120FR, in order to indicate whether performing firmware update on the micro control unit 100 is requested, where the upgrade flag may comprise one or more upgrade flag bits, which may be collectively referred to as the upgrade flag bit 120F. When the upgrade flag indicates that performing the firmware update is requested, the core circuit 110 may perform a software reset operation, for example, by executing a predetermined reset command to control the micro control unit 100 to perform a system reset operation, and start running the firmware code in the upgrade guiding procedure region 120GR to control the firmware update. Under the control of the core circuit 110, the micro control unit 100 may communicate with the host 10 by using the upgrade interface circuit 51, and more particularly, download multiple new partial firmware codes of the aforementioned new firmware code from the host 10, for replacing the original contents respectively stored in multiple partial regions of the main function procedure region 120MR one by one. Assuming that no error occurs, the micro control unit 100 can successfully replace the original firmware code in the main function procedure region 120MR with the aforementioned new firmware code.

In the embodiment shown in FIG. 1 as well as the embodiments described above, the host 50 may be implemented by way of a computer, a firmware burner, at least one other micro control unit, etc., and the upgrade interface circuit 51 may be implemented by way of peripheral interface circuits complying with associated specifications such as the Universal Asynchronous Receiver/Transmitter (UART) specification, the Inter-Integrated Circuit (I2C) specification, the Serial Peripheral Interface (SPI) specification, the Controller Area Network (CAN) specification, the Universal Serial Bus (USB) specification, the Ethernet specification, etc. In addition, the non-volatile memory 120 may be implemented by way of an electrically-erasable programmable read-only memory (EEPROM), a flash memory, etc.

For better comprehension, the main function procedure region 120MR, the upgrade flag bit region 120FR and the upgrade guiding procedure region 120GR may be arranged to store a main function procedure 120M, the upgrade flag bit 120F and an upgrade guide procedure 120G respectively, and the main function procedure 120M and the upgrade guide procedure 120G may be implemented by way of firmware codes. For example, the memory space of the non-volatile memory 120 may be expressed with memory addresses, where the main function procedure region 120MR, the upgrade flag bit region 120FR and the upgrade guiding procedure region 120GR may be arranged in continuous memory space, and arranged according to the order shown in FIG. 1, but the present invention is not limited thereto. According to some embodiments, the arrangement of the main function procedure region 120MR, the upgrade flag bit region 120FR and the upgrade guiding procedure region 120GR may vary. According to some embodiments, the main function procedure region 120MR, the upgrade flag bit region 120FR and the upgrade guiding procedure region 120GR do not need to be arranged in continuous memory space.

According to some embodiments, the core circuit 110 may selectively change the upgrade flag bit 120F to be a predetermined value among multiple predetermined values, in order to indicate whether performing the firmware update on the micro control unit 100 is requested. For example, the multiple predetermined values may comprise a first predetermined value and a second predetermined value. When detecting that the upgrade flag bit 120F is equal to the first predetermined value, the core circuit 110 running the upgrade guiding procedure 120G may determine that performing the firmware update on the micro control unit 100 is required. When detecting that the upgrade flag bit 120F is equal to the second predetermined value, the core circuit 110 running the upgrade guiding procedure 120G may determine that performing the firmware update on the micro control unit 100 is not required.

According to some embodiments, the first predetermined value may be equal to 0x5A, and the second predetermined value may be equal to 0xFF, but the invention is not limited thereto. According to some embodiments, the first predetermined value and the second predetermined value may vary.

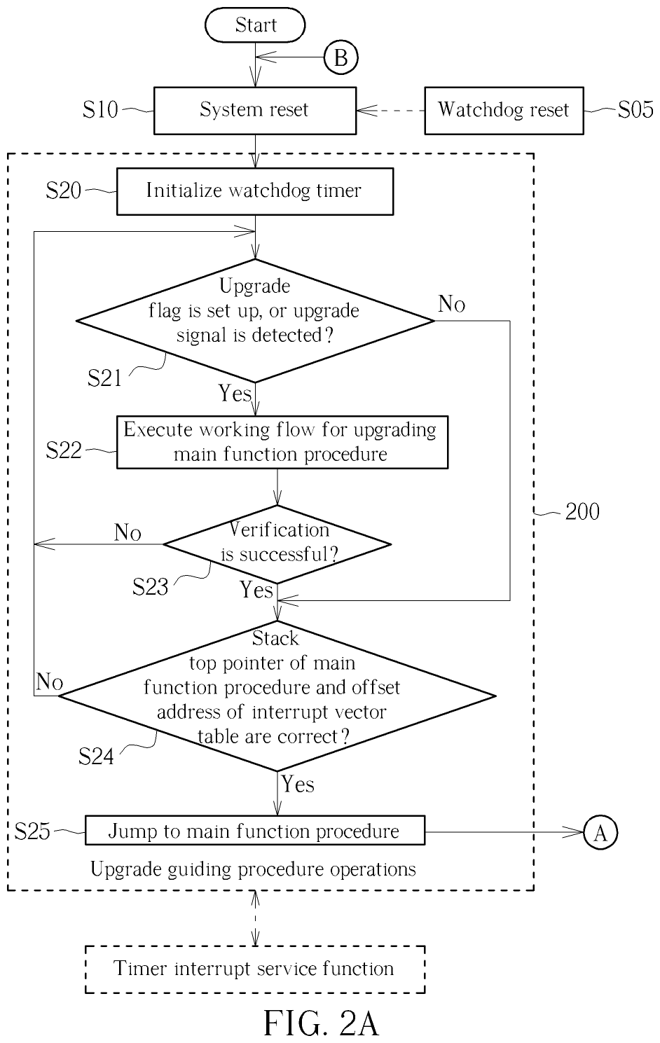

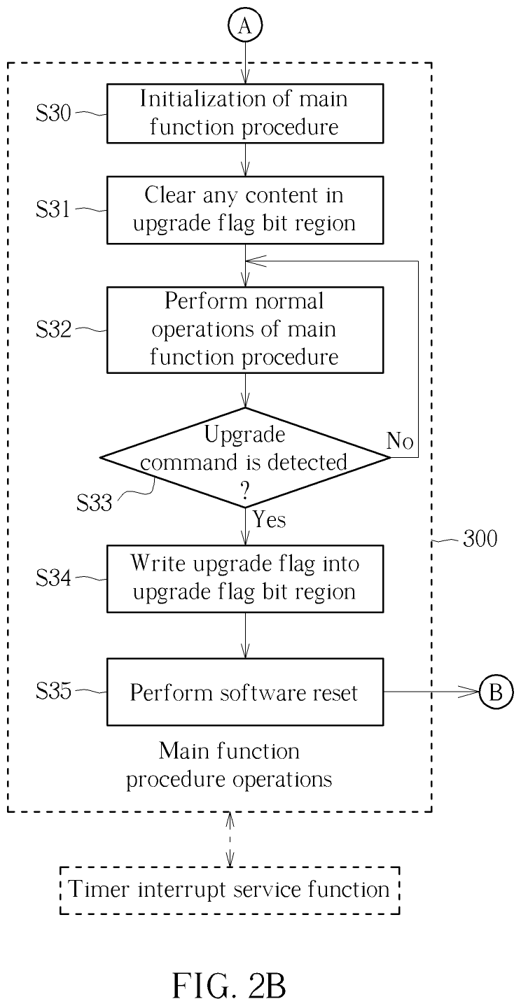

FIG. 2A and FIG. 2B respectively illustrate a first partial working flow and a second partial working flow of a main working flow of a method for performing firmware update in an electronic device according to an embodiment of the present invention, where the first partial working flow and the second partial working flow may be connected to each other through nodes A and B. The core circuit 110 may perform the upgrade guiding procedure operations 200 shown in FIG. 2A and the main function procedure operations 300 shown in FIG. 2B, and enable a watchdog timer 101 in the micro control unit 100, in order to prevent any error generated during the firmware update from immediately or subsequently causing the micro control unit 100 to malfunction and become uncontrollable. As shown in FIG. 2A and FIG. 2B, during performing the upgrade guiding procedure operations 200 or the main function procedure operations 300, the core circuit 110 may periodically execute or call a timer interrupt service function to control the watchdog timer 101 to re-enter an initial state, in order to prevent any unnecessary system reset.

In Step S05, the watchdog timer 101 may perform a watchdog reset operation to trigger the operation of Step S10. For example, if the time measured by the watchdog timer 101 expires, the watchdog timer 101 may perform the operation of Step S05. For another example, in a situation where the operation of periodically executing or calling the timer interrupt service function is successfully maintained, the time measured by the watchdog timer 101 will not expire, so Step S05 will not be executed in this situation.

In Step S10, the core circuit 110 may perform a system reset operation.

In Step S20, the core circuit 110 may initialize the watchdog timer 101, and more particularly, control the watchdog timer 101 to enter its initial state. For example, the watchdog timer 101 may comprise a counter, and may control the counter to perform counting to generate a counter value CNT, where the counter value CNT may represent the time measured by the watchdog timer 101, and the initial state may represent that the counter value CNT is equal to a predetermined initial value CNT0. After the initialization of the watchdog timer 101 is completed, the counter may start counting from the predetermined initial value CNT0 to change the counter value CNT, for example, increase the counter value CNT with a predetermined increment (e.g., 1), or decrease the counter value CNT with a predetermined decrement, but the present invention is not limited thereto.

In Step S21, the core circuit 110 may determine whether the upgrade flag is set up, or whether an upgrade signal from an external circuit is detected. If Yes (e.g., the upgrade flag is set up, or the upgrade signal is detected), Step S22 is entered; if No (e.g., the upgrade flag is not set up, and the upgrade signal is not detected), Step S24 is entered. For example, the upgrade flag being set up may represent that the upgrade flag is equal to the first predetermined value, and the upgrade flag being not set up may represent that the upgrade flag is equal to the second predetermined value.

In Step S22, the core circuit 110 may execute a working flow for upgrading the main function procedure 120M, in order to try updating the firmware code of the main function procedure 120M in the main function procedure region 120MR.

In Step S23, the core circuit 110 may perform a verification operation on the updated firmware code in the main function procedure region 120MR to determine whether the verification of the firmware update is successful, where the verification of the firmware update being successful may represent that the updated firmware code is error free. If Yes, Step S24 is entered; if No, Step S21 is entered.

For example, the core circuit 110 may obtain a predetermined checksum of the updated firmware code from the host 50, perform a predetermined calculation on the updated firmware code to generate a calculated checksum, and compare the calculated checksum with the predetermined checksum to determine whether the calculated checksum and the predetermined checksum are identical (or equal) to each other. If the calculated checksum and the predetermined checksum are identical to each other, indicating that the updated firmware code is error free, the core circuit 110 determines that the verification of the firmware update is successful; otherwise, the core circuit 110 determines that the verification of the firmware update is unsuccessful.

In Step S24, the core circuit 110 may determine whether both of a stack top pointer of the main function procedure 120M and an offset address of an interrupt vector table are correct. If Yes, Step S25 is entered; if No (e.g., the stack top pointer of the main function procedure 120M is incorrect, or the offset address of the interrupt vector table is incorrect), Step S21 is entered.

In Step S25, the core circuit 110 may jump to the main function procedure 120M.

In Step S30, the core circuit 110 may perform initialization of the main function procedure 120M.

In Step S31, the core circuit 110 may clear any content in the upgrade flag bit region 120FR. For example, the core circuit 110 may clear the upgrade flag bit region 120FR by filling the second predetermined value such as 0xFF into the upgrade flag bit region 120FR, but the invention is not limited thereto.

In Step S32, the core circuit 110 may perform the normal operations of the main function procedure 120M, in order to control the normal operations of the electronic device 50.

In Step S33, the core circuit 110 may determine whether any upgrade command from the host 50 is detected. If Yes, Step S34 is entered; if No, Step S32 is entered.

In Step S34, the core circuit 110 may write the upgrade flag into the upgrade flag bit region 120FR. For example, the core circuit 110 may set up the upgrade flag in the upgrade flag bit region 120FR by filling the first predetermined value such as 0x5A into the upgrade flag bit region 120FR, but the invention is not limited thereto.

In Step S35, the core circuit 110 may perform the aforementioned software reset operation.

For better comprehension, the method may be illustrated with the working flow shown in FIG. 2A and FIG. 2B, but the present invention is not limited thereto. According to some embodiments, one or more steps may be added, deleted, or changed in the working flow shown in FIG. 2A and FIG. 2B.

According to some embodiments, in addition to the counter, the watchdog timer 101 may further comprise a control register for controlling the watchdog timer 101. For example, the core circuit 110 may control the watchdog timer 101 to enter its initial state through the control register, and more particularly, set a register value of the control register to load the predetermined initial value CNT0 into the counter to be the counter value CNT, but the present invention is not limited thereto. According to some embodiments, the core circuit 110 may send a clear signal to the watchdog timer 101 to control the watchdog timer 101 to enter its initial state. For brevity, similar descriptions for these embodiments are not repeated in detail here.

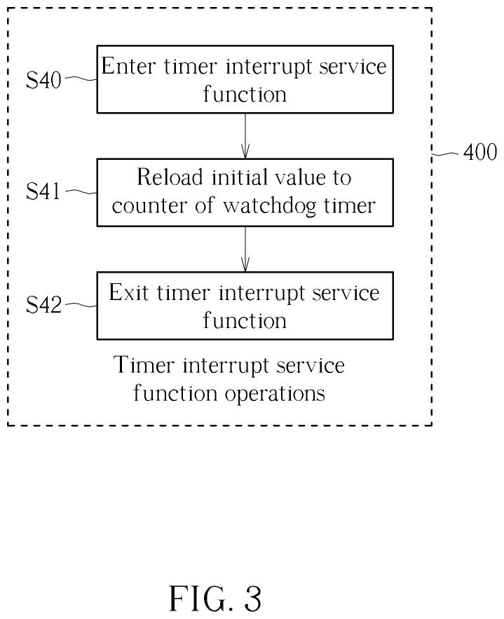

FIG. 3 illustrates the timer interrupt service function operations 400 involved with the main working flow according to an embodiment of the present invention. For example, when executing or calling the timer interrupt service function, the core circuit 110 may perform the timer interrupt service function operations 400.

In Step S40, the core circuit 110 may enter the timer interrupt service function.

In Step S41, the core circuit 110 may control the watchdog timer 101 to enter its initial state, and more particularly, reload the predetermined initial value CNT0 to the counter of the watchdog timer 101 to be the counter value CNT, thereby preventing any unnecessary system reset.

In Step S42, the core circuit 110 may exit the timer interrupt service function.

For better comprehension, the timer interrupt service function operations 400 adopted by the method may be illustrated with the working flow shown in FIG. 3, but the present invention is not limited thereto. According to some embodiments, one or more steps may be added, deleted, or changed in the working flow shown in FIG. 3.

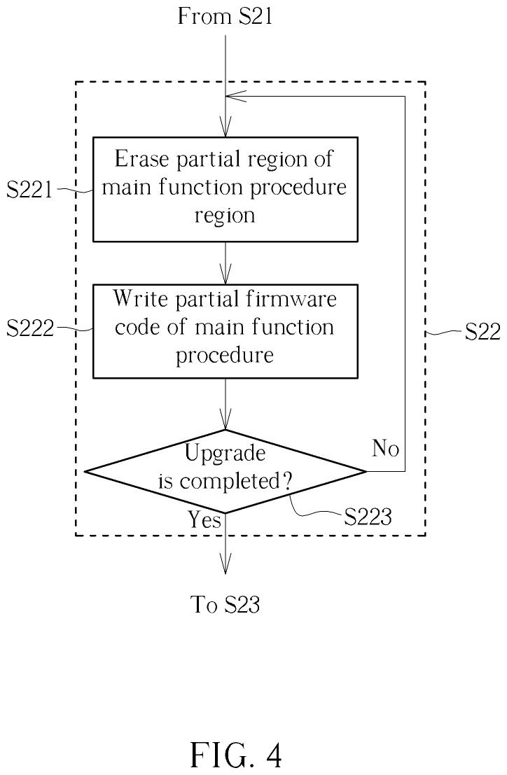

FIG. 4 illustrates some implementation details of the main working flow according to an embodiment of the present invention. For example, Step S22 shown in FIG. 2A may comprise multiple sub-steps such as Steps S221-S223, but the present invention is not limited thereto.

In Step S221, the core circuit 110 may erase a partial region among the multiple partial regions of the main function procedure region 120MR.

In Step S222, the core circuit 110 may write at least one partial firmware code of the main function procedure 120M into the main function procedure region 120MR, and more particularly, write the aforementioned at least one partial firmware code into the partial region, such as the partial region that is just erased in Step S221.

In Step S223, the core circuit 110 may determine whether the upgrade such as the firmware update is completed, where the firmware update being completed may represent that the contents of all partial regions among the multiple partial regions of the main function procedure region 120MR are erased and replaced with the new partial firmware codes. If Yes, Step S23 is entered; if No, Step S221 is re-entered.

For better comprehension, the detailed operations related to upgrading the main function procedure 120M in the method may be illustrated with the working flow shown in FIG. 4, but the present invention is not limited thereto. According to some embodiments, one or more steps may be added, deleted, or changed in the working flow shown in FIG. 4.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method performing firmware update in an electronic device, the method being applied to a micro control unit in the electronic device, the micro control unit being equipped with a non-volatile memory, memory space of the non-volatile memory comprising a main function procedure region and an upgrade guiding procedure region, the method comprising:
after system reset of the micro control unit, executing an upgrade guiding procedure in the upgrade guiding procedure region by default to start controlling upgrade of a main function procedure in the main function procedure region, wherein the main function procedure region and the upgrade guiding procedure region are arranged to store the main function procedure and the upgrade guiding procedure, respectively;
checking whether upgrade request information exists, in order to generate a first checking result, wherein the first checking result indicates that the upgrade request information exists;
in response to the upgrade request information, performing firmware update on multiple sub-regions of the main function procedure region, respectively, to generate an updated main function procedure;
performing at least one checking operation to generate at least one checking result; and
in response to the at least one checking result, starting executing the updated main function procedure in the main function procedure region.

2. The method of claim 1, wherein performing firmware update on the multiple sub-regions of the main function procedure region respectively to generate the updated main function procedure further comprises:
erasing at least one partial region of the main function procedure region, wherein the at least one partial region represents at least one sub-region among the multiple sub-regions; and
writing at least one partial firmware code of the main function procedure into the at least one partial region, wherein the at least one partial firmware code represents at least one firmware code among a set of firmware codes of the main function procedure.

3. The method of claim 1, wherein the memory space of the non-volatile memory further comprises an upgrade flag bit region for storing a multiple upgrade flag bits, wherein the multiple upgrade flag bits are arranged to indicate a state of an upgrade flag; and the micro control unit detects that the multiple upgrade flag bits indicate that the upgrade flag is in a first predetermined state, wherein the upgrade request information represents the first predetermined state.

4. The method of claim 1, wherein the micro control unit detects an upgrade signal, wherein the upgrade request information represents the upgrade signal.

5. The method of claim 1, wherein the system reset occurs multiple times to make the upgrade guiding procedure in the upgrade guiding procedure region be executed multiple times; and
the method further comprises:
checking whether the upgrade request information exists, in order to generate a second checking result, wherein the second checking result indicates that the upgrade request information does not exist; and
after obtaining the second checking result, execute the updated main function procedure in the main function procedure region.

6. A micro control unit equipped with a firmware update function, the micro control unit comprising:
a core circuit, arranged to control operations of the micro control unit; and
a non-volatile memory, coupled to the core circuit, arranged to store information, wherein memory space of the non-volatile memory comprises a main function procedure region and an upgrade guiding procedure region, for storing a main function procedure and an upgrade guiding procedure, respectively;
wherein:
after system reset of the micro control unit, the core circuit executes the upgrade guiding procedure in the upgrade guiding procedure region by default to start controlling upgrade of the main function procedure in the main function procedure region;
the core circuit checks whether upgrade request information exists, in order to generate a first checking result, wherein the first checking result indicates that the upgrade request information exists;
in response to the upgrade request information, the core circuit performs firmware update on multiple sub-regions of the main function procedure region, respectively, to generate an updated main function procedure;
the core circuit performs at least one checking operation to generate at least one checking result; and
in response to the at least one checking result, the core circuit starts executing the updated main function procedure in the main function procedure region.

7. The micro control unit of claim 6, wherein performing firmware update on the multiple sub-regions of the main function procedure region respectively to generate the updated main function procedure further comprises:
erasing at least one partial region of the main function procedure region, wherein the at least one partial region represents at least one sub-region among the multiple sub-regions; and
writing at least one partial firmware code of the main function procedure into the at least one partial region, wherein the at least one partial firmware code represents at least one firmware code among a set of firmware codes of the main function procedure.

8. The micro control unit of claim 6, wherein the memory space of the non-volatile memory further comprises an upgrade flag bit region for storing a multiple upgrade flag bits, wherein the multiple upgrade flag bits are arranged to indicate a state of an upgrade flag; and the micro control unit detects that the multiple upgrade flag bits indicate that the upgrade flag is in a first predetermined state, wherein the upgrade request information represents the first predetermined state.

9. The micro control unit of claim 6, wherein the micro control unit detects an upgrade signal, wherein the upgrade request information represents the upgrade signal.

10. The micro control unit of claim 6, wherein the system reset occurs multiple times to make the upgrade guiding procedure in the upgrade guiding procedure region be executed multiple times, wherein:
the core circuit checks whether the upgrade request information exists, in order to generate a second checking result, wherein the second checking result indicates that the upgrade request information does not exist; and
after obtaining the second checking result, the core circuit executes the updated main function procedure in the main function procedure region.
